(19) United States
(12) Patent Application Publication
(10) Pub. No.: US 2024/0273114 A1
(43) Pub. Date: Aug. 15, 2024

(54) Interactive data grouping and axis folding for enhanced graph comprehension in Cartesian coordinate systems

(71) Applicant: Minhong Mi, Newton, MA (US)

(72) Inventor: Minhong Mi, Newton, MA (US)

(21) Appl. No.: 18/629,736

(22) Filed: Apr. 8, 2024

Related U.S. Application Data
(60) Provisional application No. 63/444,894, filed on Feb. 10, 2023.

(51) Int. Cl. G06F 16/26; G06T 11/20; G06T 17/30

(52) U.S. Cl. CPC G06F 16/26; G06T 11/203; G06T 11/206; G06T 17/30

(57) ABSTRACT

Method and system are introduced for interactive data grouping and visibility alteration within graphical visualizations, leveraging a computer system to enhance user engagement and analytical depth. Users can dynamically group data points by their coordinate values along an axis in a cartesian coordinate system, facilitating a nuanced exploration of data sets. Through an intuitive interface, selections are made either by direct manipulation—clicking and dragging across a designated area—or via input dialogs for precision. This process not only organizes data into hierarchical structures for advanced analysis but also allows for the dynamic visualization of data in response to user interactions, including the expansion and collapse of data groups to simplify or detail data representations. The method extends its utility across various visual formats, adapting to a wide range of analytical needs and supporting more informed decision-making by making data exploration interactive and customizable.

### TECHNICAL FIELD

This relates in general to the field of electric data processing, and more specifically to data visualization.

### BACKGROUND

In the realm of data visualization, the ability to effectively categorize, analyze, and interpret complex datasets is crucial for extracting meaningful insights and informing decision-making processes. Current solutions in data visualization often fall short when it comes to offering users the ability to dynamically interact with and explore complex datasets in real time. Traditional methods typically provide static representations of data, severely limiting the user's ability to modify visualizations on-the-fly or to drill down into specific data points for a more detailed analysis. This rigidity hampers the discovery of deeper insights and patterns, as users are confined to pre-defined views and unable to adapt the visualization to their evolving analytical questions. Furthermore, existing systems frequently lack the capability to let users intuitively group data points based on coordinate values along a chosen axis, which is crucial for comparing, contrasting, and understanding the intricate relationships within the data. This deficiency underscores the pressing need for an innovative approach that not only bridges the gap in dynamic data interaction but also enhances the user's ability to tailor data groupings and visibility according to specific investigative criteria. Such innovation would drastically improve the utility of data visualizations, making them not just tools for representation, but powerful engines for analysis and discovery.

### SUMMARY

Described is an advanced methodology for enhancing user interaction with graphical data visualizations through interactive data grouping and dynamic visibility manipulation along a cartesian coordinate system's axes. The core innovation lies in allowing users to intuitively define and manipulate data groupings via an interactive interface or precise input dialogs, thereby organizing data points into visually distinct groups that can be expanded or collapsed. This interactive mechanism significantly improves data analysis and comprehension by facilitating a more flexible, real-time exploration of data sets. The method's adaptability across various visual formats and its ability to generate hierarchical structures of data groups cater to a wide array of analytical requirements, promoting a deeper, more insightful engagement with data. By enabling dynamic updates in response to user interactions, this invention advances the utility and efficiency of data visualization tools, supporting the evolving needs of data-driven decision-making processes across industries.

The summary is provided to introduce a selection of concepts in a simplified form and thus not intended to identify key features or essential features of the claimed subject matter, nor is it intended to be used to limit the scope of the claimed subject matter.

### BRIEF DESCRIPTION OF DRAWINGS

FIG. 1 illustrates a computing system in which the methodologies in accordance with the present invention may operate;

FIG. 2A illustrates the process of interactively selecting data points on a scatter plot by clicking and dragging along the Y-axis according to the invention;

FIG. 2B illustrates definition of an axis value group along the Y-axis according to the invention;

FIG. 2C illustrates an updated scatter plot with the axis value group along the Y-axis collapsed according to the invention;

FIG. 2D illustrates hierarchical structure of axis value groups on both X and Y axes according to the invention;

FIG. 3A depicts two line graphs before any axis value groups are collapsed according to the invention;

FIG. 3B illustrates the graphs post-collapse, applying the default treatment where null data points are deemed missing, according to this invention;

FIG. 3C demonstrates the option of connecting points immediately before and after the collapsed group's range according to this invention;

FIG. 3D illustrates the options of showing null data points and their connecting line segments as they would normally appear according to this invention;

FIG. 4A presents a three-dimensional surface plot with axis value groups defined on all axes according to this invention;

FIG. 4B reveals the transformation of the surface plot when the axis value groups are collapsed according to this invention; and

FIG. 5 displays a flowchart of the operational steps of the methodology of interactive data grouping and axis folding according to this invention.

### DETAILED DESCRIPTION

The invention presents an advanced method for interactively grouping data points by their coordinate values along one of the axes in a Cartesian coordinate system and dynamically altering their visibility according to user interactions.

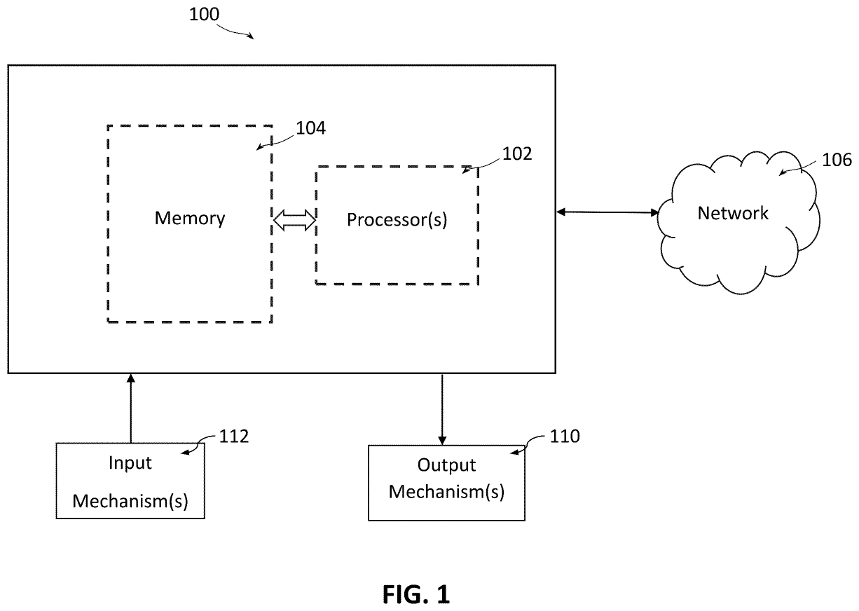

The provision of the method is facilitated by a computing system 100 as illustrated in FIG. 1, which is inclusively defined to encompass any device or amalgamation of devices equipped with at least one physical, tangible processor 102 and a corresponding physical, tangible memory 104. This memory 104, capable of storing executable instructions for the processor, may vary in form based on the computing system's design and purpose. Notably, the computing infrastructure can span across networked environments 106 incorporating multiple interconnected systems. Furthermore, the computing system 100 may include both output mechanisms 110 and input mechanisms 112. Output mechanism 110 could range from speakers and screens to more advanced options like holograms and virtual reality. Similarly, input mechanisms 112 may cover a wide spectrum, from mouses and touchscreens to various sensors and physical controls, adapting to the specific needs and functionalities of the computing system.

Subsequent details elucidate that the described methodologies are executable across various computing systems, guided by software-driven processes. These processes entail the execution of computer-readable instructions by one or more processors, thereby orchestrating the computing system's operations, including data manipulation. Such instructions are typically housed on computer-readable media, forming the basis of a computer program product.

Experts in the field will recognize the invention's compatibility with a broad spectrum of computing system configurations. These range from personal to mainframe computers, including portable devices, multi-processor systems, consumer electronics, network PCs, and even emerging technologies like wearables. The invention is equally applicable in distributed computing setups, where tasks are allocated across both proximal and distal computing entities interconnected via a mix of wired and wireless networks, with software modules distributed across local and remote storage devices.

Furthermore, the invention is adeptly suited for implementation within cloud computing environments, characterized by the dynamic allocation of computing resources over a network. This model supports various operational characteristics (like on-demand self-service and rapid elasticity) and service models, including SaaS, PaaS, and IaaS, across different deployment models such as private, public, and hybrid clouds. In essence, the description and claims encompass the employment of cloud computing as an integral environment for the invention's application.

Data visualization and analysis software are computer program products that serve as essential tools for professionals across industries to visually interpret and interact with data. If the data visualization and analysis software program were operated on the computer system 100 mentioned above, the data visualization would be displayed through the output mechanism 110 and users would be able to interact with the data visualization through the input mechanism 112.

In the rapidly evolving landscape of data-driven decision-making, it is crucial for data analysis and visualization software to be dynamic and interactive, offering users the ability to explore, manipulate, and drill down into datasets in real-time, thereby unveiling insights that might otherwise remain obscured. Dashboards and interactive charts serve as quintessential examples of this dynamic interactivity, enabling stakeholders to customize their data views, apply filters, and switch metrics on-the-fly to meet their specific analytical needs. For instance, a marketing team might use an interactive dashboard to track campaign performance across various channels, dynamically adjusting time frames or audience segments to pinpoint strategies that yield the highest ROI. Similarly, financial analysts could leverage interactive charts to explore trends in stock market data, identifying patterns and anomalies by interacting with the data directly. These applications exemplify how dynamic and interactive visualization tools empower users to not only consume data but actively engage with it, fostering a deeper understanding and more informed decision-making processes.

The data leveraged in analysis and visualization originate from a diverse range of sources. The software accommodates multiple visual formats to suit different analytical purposes and objectives. For instance, traders and financial analysts might utilize line graphs to track stock price trends over time, drawing on data from public financial databases such as Yahoo Finance. Similarly, healthcare professionals could employ bar charts to compare data across various categories, like disease case counts.

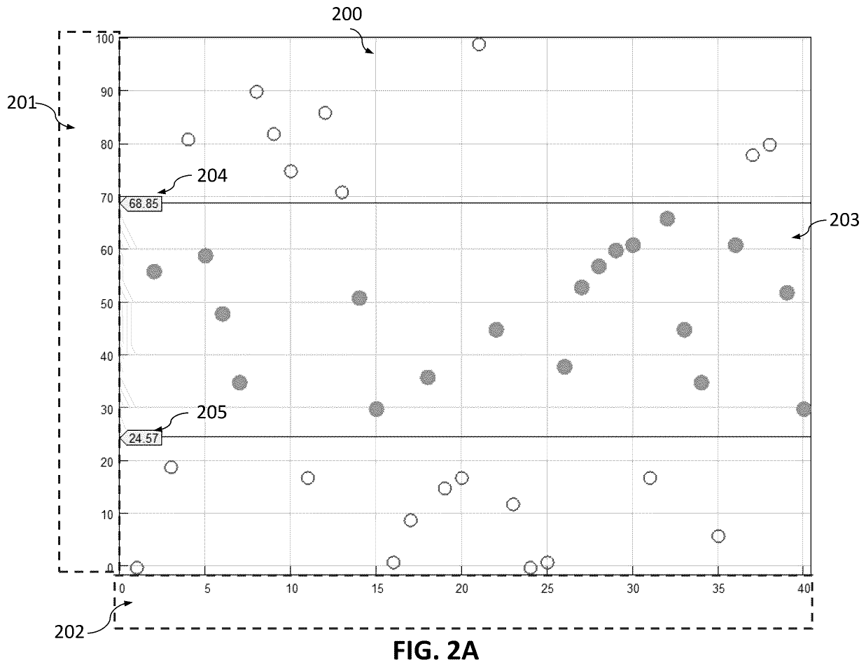

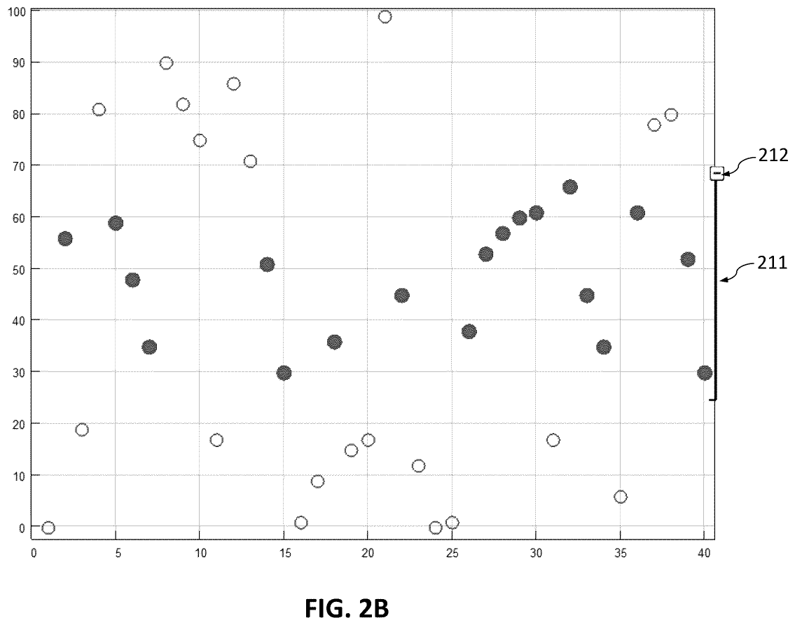

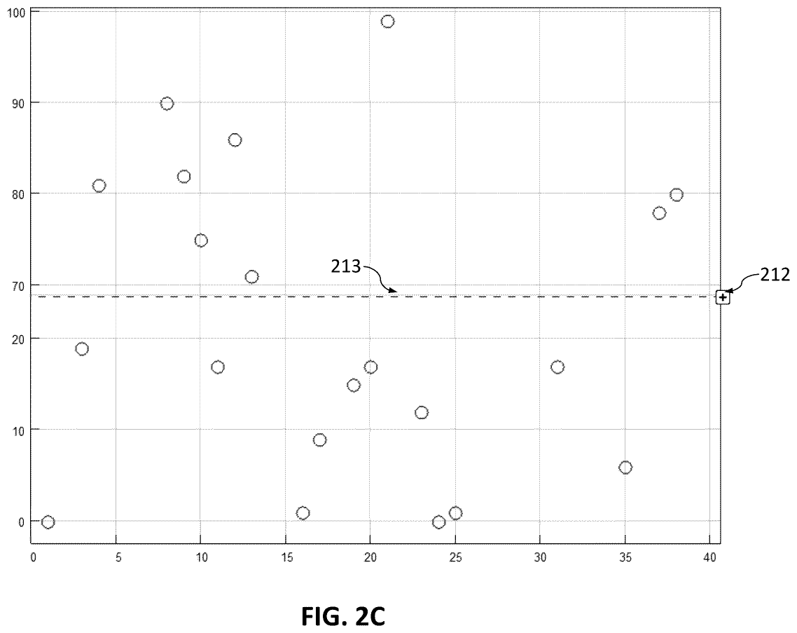

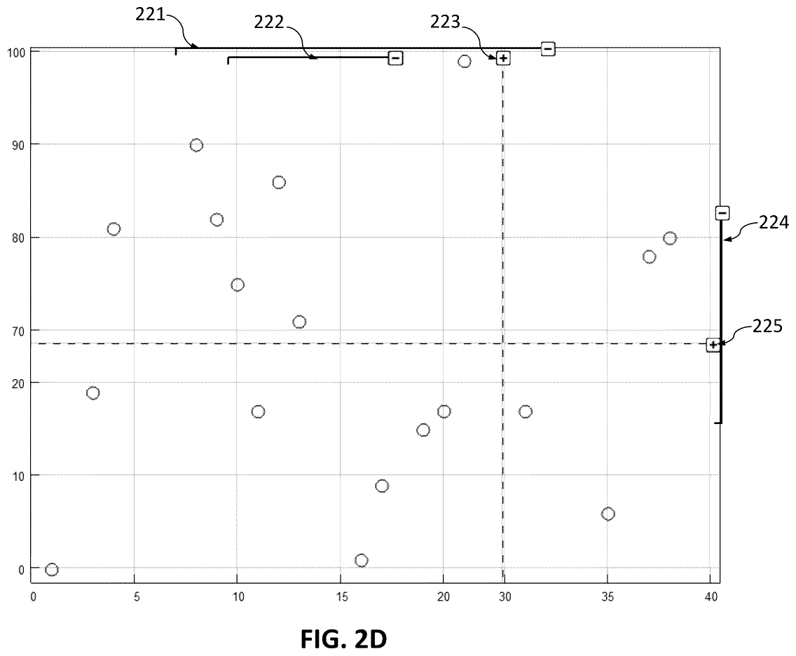

An illustrative example is provided in FIG. 2, showcasing a scatter plot 200 where each data symbol correlates to a numerical value from a data set of 40 integers. A novel aspect of the proposed invention is the introduction of an innovative feature facilitating rapid selection of data points by their coordinate values along a designated axis. This is achieved through a user-friendly interface, where moving the mouse to the rectangular area along the axis lines (marked by boxes 201 and 202) triggers a special selection mode. In this mode, dragging the mouse along the axis line highlights data points within a specific range of coordinate values, dynamically adjusted according to the mouse's current position. This selection is visually represented by an overlay (depicted as rectangle 203 with markers 204 and 205) dynamically indicating the range of selected values. Releasing the mouse finalizes the selection, distinguishing the chosen data points with filled circles, instead of the usual hollow ones.

Following the selection process, users can effortlessly create an axis value group along the chosen axis. This action is accessible through intuitive interface options, such as a context menu that appears post-selection. This interaction seamlessly informs the software to base the group on the selected axis, automatically adopting the identified range of values. Alternative methods, like direct plot area selection, prompt the user to specify the axis for group creation and/or the value ranges via standard dialogs. The resulting axis value group, illustrated in FIG. 2B, showcases its range with a line 211 parallel to the axis, together with an interactive button 212 for user engagement as described later.

Axis value groups significantly enhance data organization and manipulation, directly linking data points to specific axis ranges. Interaction with these groups, such as clicking on a representative line (211 in FIG. 2B), toggles the selection of data points within its range. Moreover, the system enables users to alter the group's status between “expanded” and “collapsed,” dynamically affecting all visualizations within the containing axes. This functionality introduces a novel approach to managing data visibility and axis continuity, as depicted in the transition between expanded and collapsed states in FIGS. 2B and 2C, respectively. Initially, an axis value group is set to “expanded,” displaying all data points normally as shown in FIG. 2B. Switching to “collapsed” by clicking the button 212 condenses the axis, omitting the group's value range, hiding all data points within the region, and creating a visual distinction with a dashed line 213 in FIG. 2C, thus maintaining axis continuity while highlighting the collapsed region. Clicking the button 212 again expands the axis value group and restores the original view as shown in FIG. 2B.

The coordinate grouping process is repeatable across any active chart axis. When newly created groups overlap in value range, the system automatically generates a child group for the intersecting range, effectively organizing data into a hierarchical structure of value groups. An example of this hierarchy is visually represented in FIG. 2D, demonstrating how parent and child groups organize overlapping ranges in both X and Y axes. Specifically, axis value group 221 is the parent of groups 222 and 223 (collapsed) defined on X axis while group 224 is the parent of the collapsed group 225 defined on Y axis.

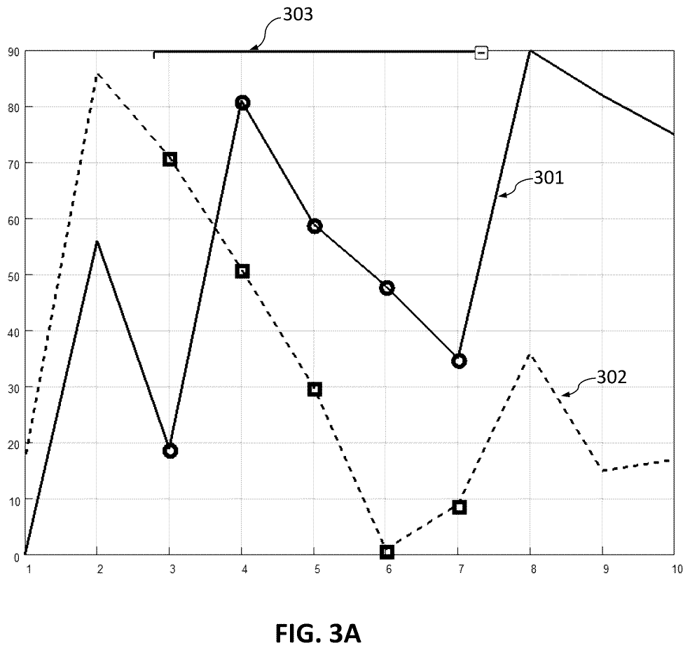

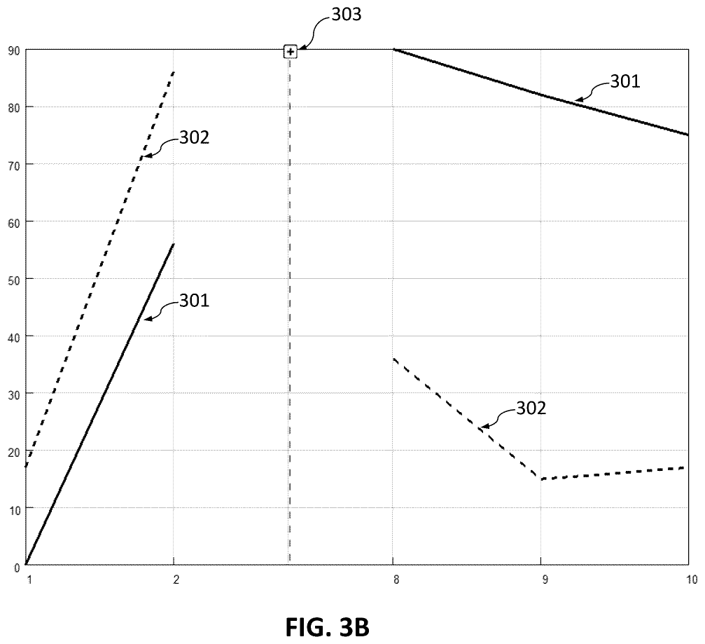

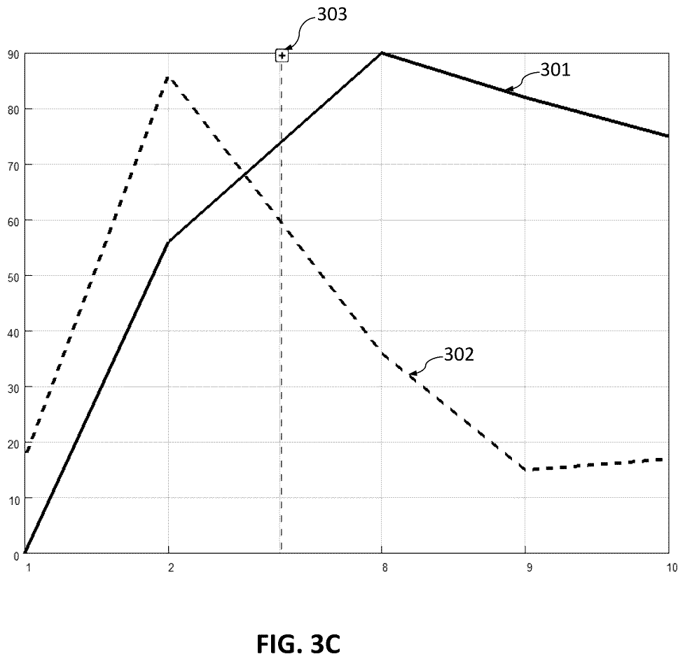

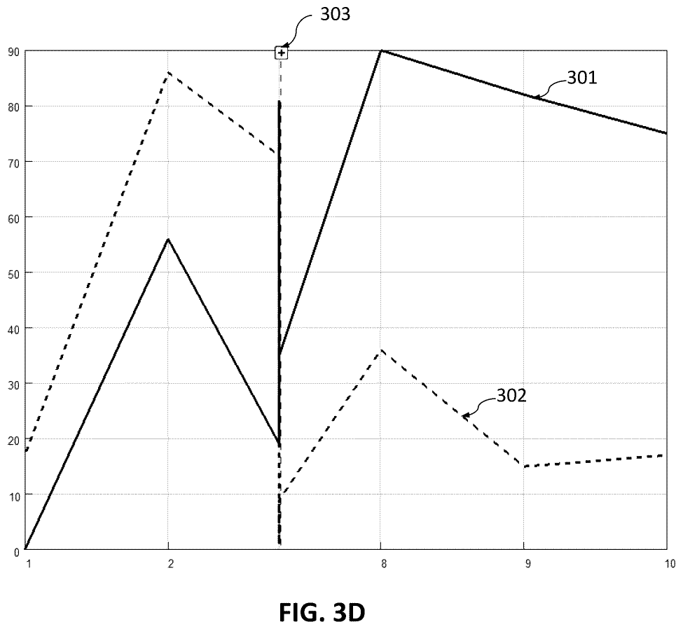

The feature of collapsing data groups introduces a concept of “null data points”, which are points whose coordinate values fall within the range of a collapsed group along a folding axis. While these null data points are simply hidden for scatter plots as exemplified in FIG. 2C, in graphical representations such as line or surface graphs, this scenario typically results in visual discontinuities, as these points are, by default, considered missing. This invention innovates by providing versatile handling options for these null data points, thereby enhancing graph readability and continuity. As exemplified with two line graphs referenced as 301 and 302, four distinct scenarios are illustrated in FIGS. 3A through 3D, demonstrating the invention's adaptability. Specifically, FIG. 3A depicts the graphs before the axis value group 303 is collapsed, showcasing the data in its “expanded” state along the X axis; FIG. 3B illustrates the graphs post-collapse, applying the default treatment where null data points are deemed missing, highlighting the visual discontinuity; FIG. 3C demonstrates an option for creating visual continuity, by connecting points immediately before and after the collapsed group's range, effectively bridging the gap; FIG. 3D explores an alternative where null data points and their connecting line segments are shown as they would normally appear, with the inherent overlap due to axis folding, thus preserving the original data representation even in a collapsed state.

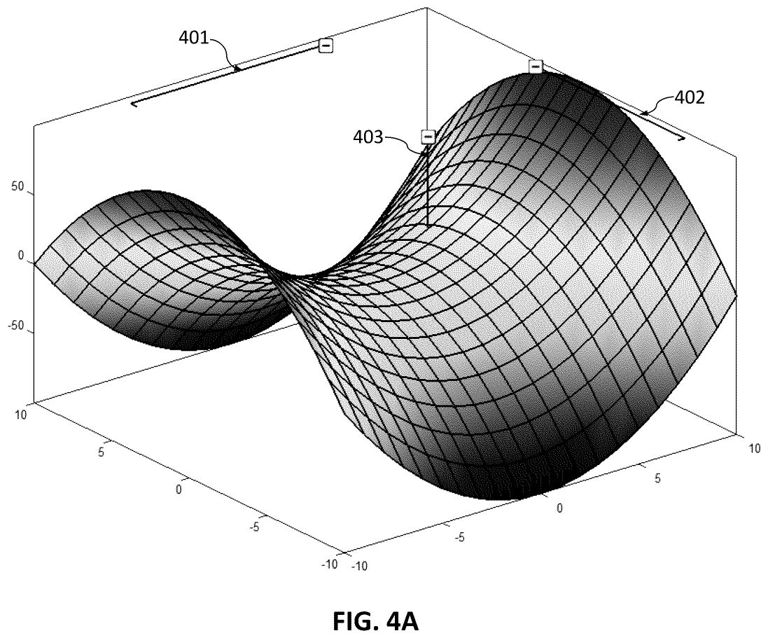

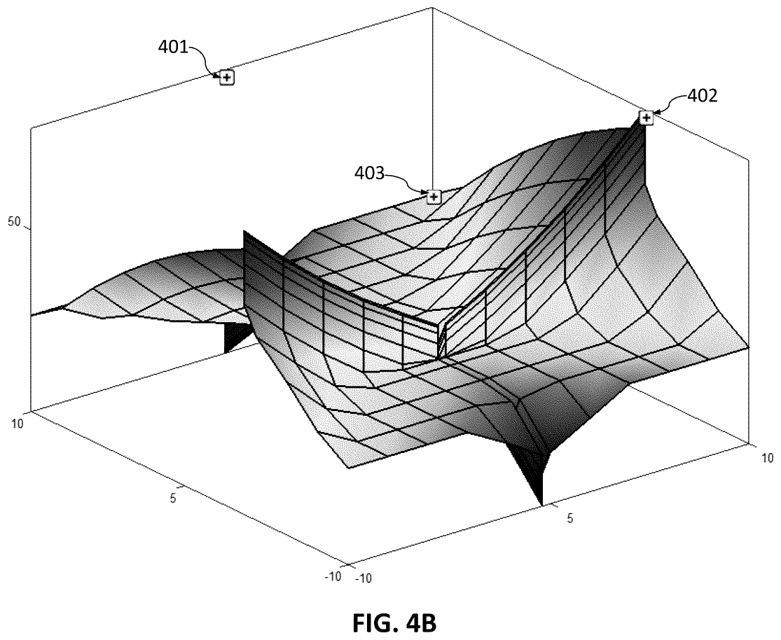

The application of this methodology extends beyond the two-dimensional scatter plots and line graphs demonstrated above, showcasing its adaptability across a range of visual formats and in three-dimensional Cartesian coordinate systems as well. To exemplify its versatility, FIG. 4A presents a three-dimensional surface plot where axis value groups-marked as 401, 402, and 403-have been delineated along the X, Y, and Z axes respectively, demonstrating the methodology's integration in multi-dimensional settings. FIG. 4B then reveals the transformation of this plot when the axis value groups are collapsed, highlighting the method's capability to maintain coherent data visualization even as it simplifies complex datasets by collapsing value groups across any number of dimensions.

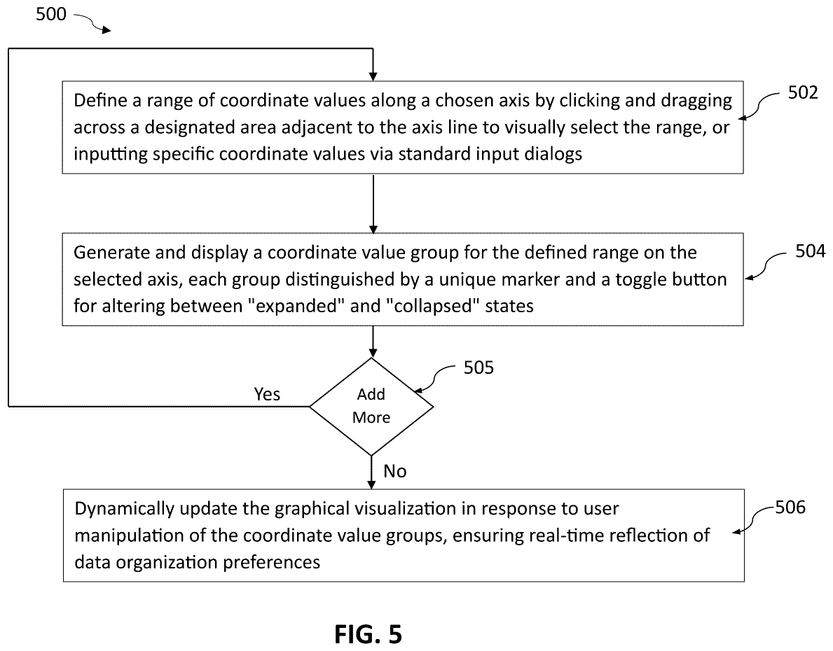

Following the introduction of the methodology's visual elements and functional capabilities through illustrative examples, we proceed to detail the operational steps and mechanics, referencing the flowchart 500 in FIG. 5. This visual guide facilitates understanding of the sequential processes involved.

The initial step, represented by block 502, involves the user actively defining a range of coordinate values along a chosen axis. This is primarily accomplished through an interactive interface, where the user can click and drag across a designated rectangular area adjacent to the axis line, or alternatively, specify the range through standard input dialogs for precision.

After setting the coordinate value range, as delineated in block 504, the system generates an axis value group corresponding to this predefined range on the selected axis. Each group is visually denoted by a distinct marker, indicating its range of values. Additionally, a toggle button is provided for each group, allowing users to switch between its “expanded” and “collapsed” states. Should any newly formed axis value group intersect with an existing group's range, the system automatically initiates the creation of a subsidiary group for the overlapping segment, thereby structuring the data into a tiered hierarchy of value groups for enhanced organizational clarity.

The process outlined in blocks 502 and 504, encompassing the definition and creation of axis value groups, is designed to be iterative, as symbolized by the decision block 505. This flexibility permits the user to establish and configure multiple groups according to their analytical needs, enriching the data exploration experience.

Represented by block 506, the system dynamically updates the graphical visualizations in reaction to user interactions with the axis value groups. This dynamic update mechanism encompasses the selection of data points within a group's range upon the activation of its marker, and the corresponding adjustment of the visualization to reflect the expanded or collapsed state of the group's value range upon toggling the provided button. This interactive element significantly enhances user engagement with the data, enabling a more intuitive and in-depth analysis.

The method detailed above brings a nuanced level of interactivity to dashboards and interactive charts, enabling users to effortlessly group and visualize data points along a chosen axis. Within a dashboard or chart, this functionality allows users to refine their data view by creating and adjusting axis value groups through simple interactions, like clicking or dragging. For instance, in a dashboard tracking environmental data, users could dynamically segment temperature readings by season to identify trends. Similarly, in a healthcare chart, patient metrics could be grouped by ranges of values for quick pattern recognition. By incorporating this method, dashboards and charts become more than static displays; they evolve into interactive platforms where data can be manipulated to reveal deeper insights. This subtle yet powerful enhancement supports better decision-making by allowing users to explore their data in a more engaging and personalized manner.

While the content discussed has been detailed using terminology specific to computer structure, methods, and computer-readable formats, it should be noted that the invention outlined in the claims attached is not confined to the particular details mentioned. Instead, these details are provided as illustrative examples of how the claims might be realized.

The subject matter outlined above is intended purely for illustrative purposes and should not be seen as restrictive. It is possible to apply various alterations and modifications to the described content without straying from the example embodiments and applications presented, and without deviating from the genuine essence and breadth of the current invention, as delineated in the subsequent claims.

What is claimed is:

1. A method executed by a computer system for enhancing user interaction with and comprehension of graphical visualizations through interactive data grouping and axis folding, the method comprising steps of:
initiating an interactive interface that allows a user to define a range of coordinate values along a chosen axis by either clicking and dragging across a designated area adjacent to the axis line to visually select the range or inputting specific coordinate values via standard input dialogs for precise selection;
generating and displaying an axis value group for the defined range on the selected axis, each group distinguished by a unique marker that denotes its value range and equipped with a toggle feature for altering between “expanded” and “collapsed” visual states of the group; and
dynamically updating the graphical visualization in response to user manipulation of the axis value groups, ensuring real-time reflection of data organization preferences.

2. The method of claim 1, further comprising a capability for users to repetitively apply the method for data grouping across multiple axes within any active graphical visualization, thereby enhancing the versatility and applicability of data analysis across various chart types.

3. The method of claim 2, further incorporating the generation of hierarchical child groups when new coordinate value ranges intersect with existing groups, thereby facilitating the organization of data into a multi-level structure that reflects complex data relationships and intersections more accurately.

4. The method of claim 1, wherein the dynamic updating mechanism includes:
selecting and highlighting data points within a group's defined range upon the activation of its unique marker; and
adjusting the graphical visualization to accurately depict the selected group's data points in either an expanded or collapsed state, based on the user's toggle interaction.

5. The method of claim 4, wherein transitioning an axis value group to its collapsed state results in a condensed visualization along the affected axis by omitting the specified range from the display, thereby simplifying the visualization by hiding all data points within the collapsed range for streamlined analysis.

6. The method of claim 5, offering flexible handling mechanisms for data points within a collapsed group's range on a folding axis, including options to:
treat data points falling within the collapsed range as absent, thereby accentuating visual discontinuities;
connect data points located immediately before and after the collapsed range with a visual line, bridging the gap for continuous data representation; and
maintain the display of all data points and their connections within the collapsed range as per their original positions, allowing for an overlapped visualization due to axis folding, thus preserving the integrity of the original data set despite the collapsed state.

7. A computer system comprising:
a processor; and
a computer-readable storage medium having computer-executable instructions stored thereon which, when executed by a computer, cause the apparatus to perform operations comprising:
initiating an interactive interface that allows a user to define a range of coordinate values along a chosen axis by either clicking and dragging across a designated area adjacent to the axis line to visually select the range or inputting specific coordinate values via standard input dialogs for precise selection;
generating and displaying a axis value group for the defined range on the selected axis, each group distinguished by a unique marker that denotes its value range and equipped with a toggle feature for altering between “expanded” and “collapsed” visual states of the group; and
dynamically updating the graphical visualization in response to user manipulation of the axis value groups, ensuring real-time reflection of data organization preferences.

8. The computer system of claim 7, further comprising a capability for users to repetitively apply the method for data grouping across multiple axes within any active graphical visualization, thereby enhancing the versatility and applicability of data analysis across various chart types.

9. The computer system of claim 8, further incorporating the generation of hierarchical child groups when new coordinate value ranges intersect with existing groups, thereby facilitating the organization of data into a multi-level structure that reflects complex data relationships and intersections more accurately.

10. The computer system of claim 7, wherein the dynamic updating mechanism includes:
selecting and highlighting data points within a group's defined range upon the activation of its unique marker; and
adjusting the graphical visualization to accurately depict the selected group's data points in either an expanded or collapsed state, based on the user's toggle interaction.

11. The computer system of claim 10, wherein transitioning an axis value group to its collapsed state results in a condensed visualization along the affected axis by omitting the specified range from the display, thereby simplifying the visualization by hiding all data points within the collapsed range for streamlined analysis.

12. The computer system of claim 11, offering flexible handling mechanisms for data points within a collapsed group's range on a folding axis, including options to:
treat data points falling within the collapsed range as absent, thereby accentuating visual discontinuities;
connect data points located immediately before and after the collapsed range with a visual line, bridging the gap for continuous data representation; and
maintain the display of all data points and their connections within the collapsed range as per their original positions, allowing for an overlapped visualization due to axis folding, thus preserving the integrity of the original data set despite the collapsed state.
